(19) United States
(12) Patent Application Publication
(10) Pub. No.: US 2007/0200801 A1
(43) Pub. Date: Aug. 30, 2007

(54) Display device

(75) Inventors: Tomoki Nakamura, Chiba (JP); Katsuhide Aoto, Chiba (JP); Masakazu Sagawa, Inagi (JP); Toshiaki Kusunoki, Tokorozawa (JP); Toshimitsu Watanabe, Yokohama (JP); Yoshiro Mikami, Hitachiota (JP)

Correspondence Address: MILBANK, TWEED, HADLEY & MCCLOY, 1 CHASE MANHATTAN PLAZA, NEW YORK, NY, 10005-1413, US

(73) Assignee: Hitachi Displays, Ltd.

(21) Appl. No.: 11/707,807

(22) Filed: Feb. 16, 2007

(30) Foreign Application Priority Data
Feb. 24, 2006 (JP) 2006-047679

(51) Int. Cl. G09G 3/22

(52) U.S. Cl. 345/74.1

(57) ABSTRACT

In a display device is capable of performing the gradation display of high bits by regulating the sheet resistance of the signal lines according to the set operation conditions of a display panel, plural pixels that are formed of plural sub-pixels each consisting of a pair of a cathode and a phosphor layer are arranged in a matrix to constitute a two-dimensional display region, and wherein when Ry is a vertical resolution of the display region, η is a cathode efficiency, Ies is a peak current per color sub-pixel, Ed [V] is the maximum amplitude of a drive voltage that is applied to the signal lines, b is the number of gradation bits, and SR[Ω/□] is a sheet resistance of the signal lines, SR<η·Ed/3·2^{b}·Ies·Ry is satisfied.

### CLAIM OF PRIORITY

The present application claims priority from Japanese Application JP 2006-047679 filed on Feb. 24, 2006, the content of which is hereby incorporated by reference into this application.

### BACKGROUND OF THE INVENTION

(1) Field of the Invention

The present invention relates to display devices using electron emission into vacuum, and more particularly to a light emitting flat panel display device that seals a back panel having cathodes (electron source) that emit electrons and a front panel having phosphor layers of plural colors which emit light by excitation of electrons that are extracted from the back panel and an anode with a sealing frame.

(2) Description of the Related Art

As the light-emitting flat panel display device that is excellent in high brightness and high fineness, a liquid crystal display device and a plasma display device have been put in practical use. More particularly, as display devices that enable the high brightness, flat panel display devices of various types (panel display devices) such as an electron emission display device using electron emission into vacuum from an electron source, a field emission display device, or an organic EL display featured by a low power consumption have been so studied as to be put into practical use. The plasma display device that does not require an auxiliary light source, the electron emission display device, and the organic EL display device are called “light emitting flat panel display device”.

As the cathode in the light emitting flat panel display device, there have been known a cathode with a cone-shaped field emission structure that has been invented by C. A. Spindt, et al, a cathode with a metal insulator metal (MIM) type electron emission structure, a cathode with an electron emission structure (also called “surface conduction electron source”) using an electron emission phenomenon attributable to a quantum tunnel effect, a cathode using an electron emission phenomenon provided by a diamond film, a graphite film, or a nanotube represented by carbon nanotube. The technique related to the MIM type electron emission structure among the display device of the above type is disclosed in Japanese Patent Laid Open No. H09-199065 or Japanese Patent Laid Open No. 2000-251778.

### SUMMARY OF THE INVENTION

In the display device of the above type, the sheet resistance of the signal lines is more brought question as the screen size is larger. Normally, the supply of the drive voltage to the signal lines is conducted from one side of the panel. Also, the wiring width of the signal line is narrowed as the fineness of the display image is higher. Accordingly, the resistance is increased as the signal lines are farther from a power feeder terminal, thereby making it impossible to execute the gradation display with higher bits. As a result, it is difficult to realize the display with even high fineness and even high brightness on the overall screen.

An object of the present invention is to realize the even high-fineness and high-brightness display over the overall screen that enables the high gradation display.

In order to achieve the above object, the present invention applies the following configurations.

That is, according to the present invention, there is provided a light-emitting flat panel display device includes:

a back panel including a large number of scanning lines that extend in a first direction, are arranged in a second direction which crosses the first direction, and supplies a horizontal scanning signal, a large number of signal lines that extend in the second direction so as to interpose an insulating layer between the signal lines and the scanning lines, and arranged in the first direction, a drive signal of display data being supplied to the signal lines, and cathodes that connect the scanning lines and the signal lines;

a front panel including phosphor layers of plural colors which emit light by excitation of electrons that are extracted from the cathodes, and an anode that applies an accelerating voltage to an electron source; and

a sealing frame that is interposed in a peripheral portion between the back panel and the front panel to produce a depressurized internal space.

In the display device, a plurality of pixels that are formed of a plurality of sub-pixels which are formed by a pair of the cathode and the phosphor layer are arranged in a matrix to constitute a two-dimensional display region, and

when Ry is a vertical resolution of the display region, η is a cathode efficiency, Ies is a peak current per color sub-pixel, Ed [V] is the maximum amplitude of a drive voltage that is applied to the signal lines, b is the number of gradation bits, and SR[Q/O] is a sheet resistance of the signal lines, SR<η·Ed/3·2^{b}·Ies·Ry is satisfied.

Also, according to the present invention, when V [m] is a diagonal dimension of the display region, Rx is the number of pixels in a horizontal direction, Ea [V] is an anode voltage, Eaₜₕ [V] is a light emission start anode voltage, η is a cathode efficiency, Bp [cd/m²] is a peak brightness, Ed [V] is the maximum amplitude of a drive voltage, and b is the number of gradation bits, a sheet resistance SR[Ω/□] of the signal lines satisfies SR<Cη·Ed(Ea−Eaₜₕ)·Rx/3·2^{b}·Bp·V² (C is a constant).

Also, according to the present invention, when V [m] is a diagonal dimension of the display region, Rx is the number of pixels in a horizontal direction, Ea [V] is an anode voltage, q is a cathode efficiency, and Bp [cd/m²] is a peak brightness, a sheet resistance SR [Ω/□] of the signal lines satisfies SR<0.00047η·(Ea−3000)·Rx/Bp·V².

Also, according to the present invention, when a diagonal dimension of the display region is nominal 32 inches, the number of pixels in a horizontal direction is 1366, the number of pixels in a vertical direction is 768, an anode voltage is 7 kV, a cathode efficiency is η, and a peak brightness is 500 [cd/m²], a sheet resistance SR [Ω/□] of the signal lines satisfies SR<7.775 η. More specifically, the sheet resistance of the signal lines is 0.38875 [Ω/□].

According to the configuration of the present invention, it is possible to provide the gradation display of high bits which realizes the even high-fineness and high-brightness display over the entire screen.

### BRIEF DESCRIPTION OF THE DRAWINGS

These and other objects and advantages of this invention will become more fully apparent from the following detailed description taken with the accompanying drawings in which:

FIG. 1 is a partially broken perspective view showing the overall configuration of a light-emitting flat panel display device according to the present invention;

FIG. 2 is a cross-sectional view taken along a line A-A′ of FIG. 1;

FIGS. 3A to 3C are diagrams for explaining an example of a cathode in FIGS. 1 and 2; and

FIG. 4 is an explanatory diagram showing an equivalent circuit example of the light-emitting flat panel display device according to the present invention.

### DETAILED DESCRIPTION OF THE PREFERRED EMBODIMENTS

Now, a description will be given in more detail of preferred embodiments of the present invention with reference to the attached drawing.

### First Embodiment

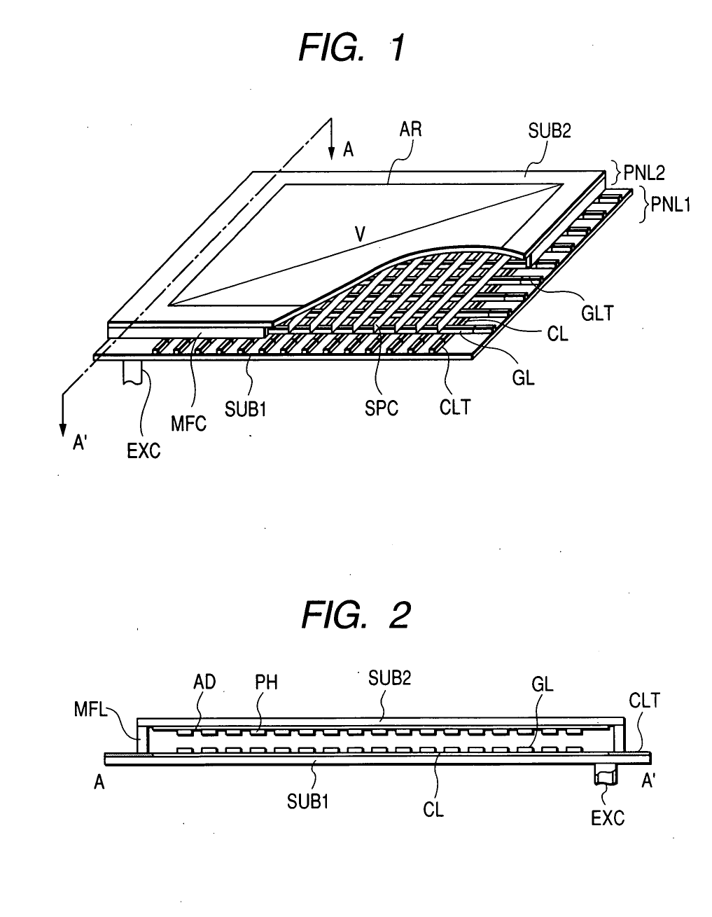

FIG. 1 is a partially broken perspective view showing the overall configuration of a light-emitting flat panel display device according to the present invention. FIG. 2 is a cross-sectional view taken along a line A-A′ of FIG. 1. A back panel PNL1 has cathodes formed in the vicinity of crossing portions of signal lines CL and scanning lines GL on an inner surface of a back substrate SUB1 so as to be arranged in a matrix. On the other hand, a front panel PNL2 has a front substrate SUB2 formed of a transparent glass substrate, and also has an anode AD and a phosphor layer PH formed on an inner surface of the front substrate SUB2. The anode AD is formed of an aluminum layer. Signal line lead lines CLT are formed at ends of the signal lines CL on edges of the back substrate SUB1, and scanning line lead lines GLT are formed at ends of the scanning lines GL on the edges of the back substrate SUB1.

The front panel PNL2 and the back panel PNL1 face each other, and in order to keep a predetermined interval between the front panel PNL2 and the back panel PNL1, ribs or spacers (partitions, not shown) which are, for example, about 80 μm in width and about 2.5 mm in height extend on the scanning lines GL and along the extending direction of the scanning lines GL, and are fixed. A sealing frame MFL made of glass is located on the peripheral portions of both of those panels. The sealing frame MFL is fixed by means of a frit glass (joint glass) so that an internal space interposed between both of those panels provides a depressurized space or vacuum space structure which is isolated from the external. In fixation of the spacers made of frit glass, heating is conducted at about 400° C. Thereafter, the interior of the device is sealed after gas is exhausted down to about 1 μPa from the interior of the device through an exhaust tube EXC. In FIG. 1, reference AR denotes a display region, and V denotes a diagonal distance.

As the cathodes used in the above-mentioned light-emitting flat panel display device, there are an MIM, an SED, and a BSD. The cathode of this type is small in the rate of the emission current to the drive current. When it is assumed that a peak emission current per sub-pixel is Ies, the emission efficiency is η, and a peak drive current per sub-pixel is. Ids, the following expression is satisfied.

Ies=ηIds (1)

Normally, the emission efficiency is η=1 to 5%.

Because the voltage drop in the signal lines at the time of driving is developed by the peak drive current Ids, a large voltage drop is liable to occur as compared with the emission current. When the voltage drop within the display region of the panel becomes larger than a voltage value corresponding to the minimum bit of the gradation display, a signal is not correctly supplied to the pixel. When the maximum amplitude of the drive voltage is Ed, and the number of gradation bits is b, a voltage value ΔEd corresponding to the minimum bit is represented by the following expression.

ΔEd=Ed/2^{b} (2)

In order to correctly supply the signal to the pixel, the resistance R of the signal lines within the display region is required to satisfy the following expression.

R≦ΔEd/Ids=ηEd/2^{b}Ies (3)

When the number of pixels in the vertical direction is Ry, the number of pixels in the horizontal direction is Rx, an area of the display region is S, and the pixel pitch is P, the following relationship is established.

P=V/\sqrt{(Rx²+Ry²)} (4)

S=(Rx·Ry)V²/(Rx²+Ry²) (5)

In order to reduce the voltage drop, it is preferable that the signal lines are shorter. When the signal lines are arranged in the vertical direction, the length S1 of the signal lines within the display region is obtained by multiplying the number of pixels in the vertical direction by the pixel pitches. As a result, the signal line length S1 is represented by the following expression.

S1=RyP=RyV/\sqrt{(Rx²+Ry²)} (6)

In this situation, when the line width of the signal lines is Sw, the sheet resistance SR of the signal lines is represented by the following expression.

SR=RSw/S1 (7)

### In order that R satisfies Expression (3), it is necessary to satisfy the following expression (8). That is,

SR≦ηEdSw/2^{b}IesS1=ηEdSw\sqrt{(Rx²+Ry²)}/2^{b}IesRyV (8)

Hence, the following expression is satisfied.

SR<ηEd/3·2^{b}IesRy (9)

The flow current into the anode and the peak brightness Bp establish the proportional relationship. For that reason, the peak emission current Ies per sub-pixel is represented as follows.

Ies∞Bp (10)

Likewise, in the case where the brightness is constant, because the flow current into the anode is in proportion to the area S of the display region, the following expression is obtained by Expression (5).

Ies∞V² (11)

The anode voltage Ea establishes the linear relationship with the peak brightness Bp when the anode voltage Ea exceeds a light emission start anode voltage Eaₜₕ. For that reason, in the case where the brightness is held constant, the following expression is established.

Ies∞1/(Ea−Eaₜₕ) (12)

Also, when the anode current is constant, since the number of pixels and the emission current Ies are in inverse proportion to each other, the following expression is satisfied.

Ies∞1/Rx·Ry (13)

From the above expressions, the following expressions are established.

Ies∞Bp·V²/(Ea−Eaₜₕ)·Rx·Ry

Hence, 1/Ies∞(Ea−Eaₜₕ)·Rx·Ry/Bp·V² (14)

The following expressions (15) and (16) are satisfied according to Expressions (9) and (14).

SR<Cη·Ed(Ea−Eaₜₕ)·Rx/3·2^{b}·Bp·V² (C is a constant) (15)

where C=Bp·V²/Ies·(Ea−Eaₜₕ)·Rx·Ry (16)

In the case where a display device in which the diagonal dimension V of the display region is nominal 32 inches (about 0.8 m), and the number of pixels is 136 in horizontal (H)×768 in vertical (V) is constituted, when the peak brightness is 500 cd/m² under the condition of the anode voltage Ea=7 kV, a current value per sub-pixel is 0.00109 mA. Also, since Eaₜₕ=3 kV is satisfied from the experimental fact, the constant C is 0.0722 cd/W from Expression (16). In order to suppress the driver circuit inexpensively, it is necessary that the drive voltage is a TTL level. Accordingly, Ed=5 [V] is satisfied. The gradation of at least eight bits is required from the characteristics of the existing plasma display panel (PDP) or the liquid crystal display panel (LCD). Hence, b=8 is satisfied.

From the above viewpoint, Expression (15) is rewritten, and the diagonal dimension V [m] of the display region, the number of pixels in the horizontal direction Rx, the anode voltage Ea [V], the emission efficiency (cathode efficiency) η, the peak brightness Bp (cd/m²), and the sheet resistance SR of the signal lines [Ω/□] establish the following relationship.

SR<0.00047·η·(Ea−3000)·Rx/BpV² (17)

In order to constitute a display device in which the diagonal dimension V of the display region is nominal 32 inches, 136 pixels in horizontal (H)×768 pixels in vertical (V), the anode voltage Ea=7 kV, and the beak brightness is 500 cd/m², the sheet resistance SR [Ω/□] of the signal lines needs to meet the following expression.

SR<7.775·η (18)

Also, since it is estimated that the cathode efficiency η is 5% or lower, the following expression is satisfied.

SR<0.38875 (19)

Now, a description will be given of the cathode in the display device that meets the above conditions.

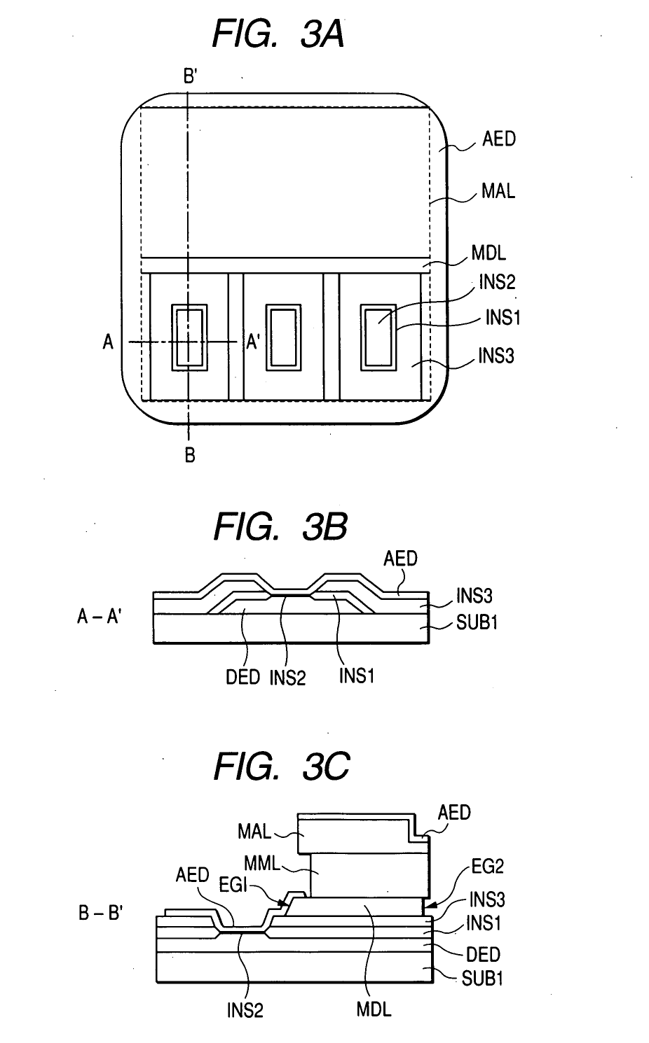

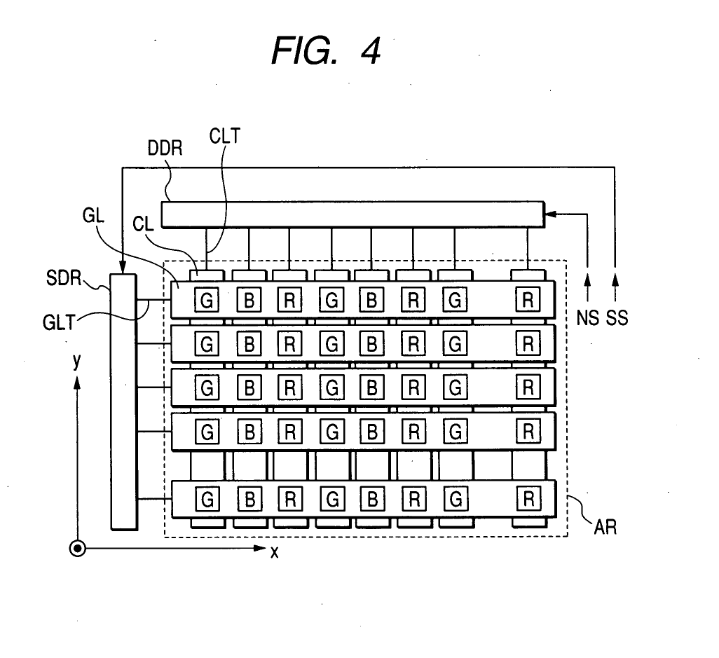

FIGS. 3A to 3C are diagrams for explaining an example of the cathode in FIGS. 1 and 2. FIG. 3A is a plan view, FIG. 3B is a cross-sectional view taken along a line A-A′ of FIG. 3A, and FIG. 3C is a cross-sectional view taken along a line B-B′ of FIG. 3A. The cathode is a MIM electron beam.

The configuration of the cathode will be described with reference to the cathode manufacturing process. First, a lower electrode DED, a protective insulating layer INS1, and an insulating layer INS2 are formed on a back substrate (glass substrate) SUB1. Then, an inter-layer insulating membrane INS3, an upper bus electrode that is an electric feeder line to an upper electrode AED, and a metal membrane that forms a spacer electrode for arranging a spacer (not shown) are formed thereon through a sputtering method. The inter-layer insulating membrane INS3 can be made of, for example, silicon oxide, a silicon nitride membrane, or silicon. In this example, the silicon nitride membrane is used, and the thickness is 100 nm. In the case where a pin hole is formed in the protective insulating layer INS1 that is formed by anodic oxidation, the inter-layer insulating membrane INS3 is filled in the defect, and has a function of keeping insulation between the lower electrode DED and the upper bus electrode that is the scanning lines (three-layer laminated membrane having Cu as a metal film intermediate layer MML interposed between the metal membrane lower layer MDL and the metal membrane upper layer MAL).

The upper bus electrode that forms the scanning lines is not limited to the above three-layer laminated membrane, but can be the more than three layers. For example, the metal film membrane lower layer MDL and the metal membrane upper layer MAL can be made of metal material high in oxidation resistance such as aluminum (Al), chrome (Cr), tungsten (W), or molybdenum (Mo), alloy containing those metal materials, or a laminated membrane of those materials. In this example, the metal membrane lower layer MDL and the metal membrane upper layer MAL are made of Al—Nd alloy. Also, the metal membrane lower layer MDL is formed of a laminated membrane of Al alloy and Cr, W, Mo, and the metal membrane upper layer MAL is formed of a laminated membrane of Cr, W, or Mo and Al alloy so that a membrane that is in contact with Cu of the metal membrane interlayer layer MML is formed of a five-layer membrane made of a high melting point. In this configuration, since the high melting metal forms a barrier membrane so as to suppress the alloying of Al and Cu in conducting the heating process in the process of manufacturing the image display device, this configuration is particularly effective in the resistance reduction.

In the thickness of the Al—Nd alloy in the case of using only Al—Nd alloy, the metal membrane upper layer MAL is made thicker than the metal membrane lower layer MDL, and the metal membrane intermediate layer MML is thickened as much as possible because Cu of the metal membrane intermediate layer MML reduces the wiring resistance. In this example, the metal membrane lower layer MDL is 300 nm in thickness, the metal membrane intermediate layer MML is 4 μm, and the metal membrane upper layer MAL is 450 nm in thickness. Also, Cu of the metal membrane intermediate layer MML can be formed through electrodeposition other than sputtering.

In the case of the above five-layer membrane made of the high melting point metal, it is particularly effective to use the laminated layer membrane having Cu interposed between Mo which enables wet etching, particularly, in a mixture aqueous solution of phosphoric acid, acetic acid, and nitric acid as the metal membrane intermediate layer MML as with Cu. In this case, the thickness of Mo between which Cu is interposed is 50 nm, and the Al alloy of the metal membrane lower layer MDL is 300 nm and the Al alloy of the metal membrane upper layer MAL is 50 nm in thickness, between which the metal membrane intermediate layer is interposed.

Subsequently, the metal membrane upper layer MAL is processed in a stripe configuration that crosses the lower electrode DED through the resist patterning and etching processes due to screen printing. In the etching process, for example, wet etching in the mixture aqueous solution of phosphoric acid and acetic acid is used. Nitric acid is not added in the etching solution, thereby making it possible to selectively etch only the Al—Nd alloy without etching Cu.

Similarly, in the case of the five-layer membrane using Mo, nitric acid is not added in the etching solution, thereby making it possible to selectively etch only the Al—Nd alloy without etching Mo and Cu. In this example, one metal membrane upper layer MAL is formed per one pixel, but two metal membrane upper layers MAL can be used instead.

Then, the same resist membrane is used as it is, or Cu of the metal membrane intermediate layer MML is wetly etched by, for example, the mixture aqueous solution of phosphoric acid, acetic acid, and nitric acid with the Al—Nd alloy of the metal membrane upper layer MAL as a mask. Because the etching rate of Cu in the etching solution of the mixture aqueous solution of phosphoric acid, acetic acid, and nitric acid is sufficiently higher than that in the Al—Nd alloy, it is possible to selectively etch only Cu of the metal membrane intermediate layer MML. Similarly, in the case of the five-layer membrane using Mo, the etching rate of Mo and Cu is sufficiently higher than that of the Al—Nd alloy, thereby making it possible to selectively etch only the three-layer laminated membrane of Mo and Cu. Also, ammonium persulfate aqueous solution and sodium persulfate aqueous solution are also effective in etching of Cu.

Subsequently, the metal membrane lower layer MDL is processed in a stripe configuration that crosses the lower electrode DED through the resist patterning and etching processes due to screen printing. The etching process is conducted by wet etching in the mixture aqueous solution of phosphoric acid and acetic acid. In this situation, the resist film to be printed is shifted in position in a direction parallel to the stripe electrode of the metal membrane upper layer MAL. As a result, one side EG1 of the metal membrane lower layer MDL forms a contact portion that jetties from the metal membrane upper layer MAL and ensures the connection with the upper electrode AED in a post process, and an overetching process is conducted with the metal membrane upper layer MAL and the metal membrane intermediate layer ML as masks at an opposite side EG2 of the metal membrane lower layer MDL, thus forming a retreat portion so as to form a seam in the metal membrane intermediate layer MML.

The seam of the metal membrane intermediate layer MML allows the upper electrode AED that is formed in the post process to be separated. In this situation, since the metal membrane upper layer MAL is made thicker than the metal membrane lower layer MDL, the metal membrane upper layer MAL can remain on Cu of the metal membrane intermediate layer MML even if the etching of the metal membrane lower layer MDL is completed. As a result, since the surface of Cu can be protected, it is possible to form the upper bus electrode that forms the scanning signal lines which has oxidation resistance, separates the upper electrode AED in the self-alignment, and conducts electric feed even if Cu is used. Also, in the case of the metal membrane intermediate layer MML of a five-layer film where Cu is interposed between Mo, even if the Al alloy of the metal membrane upper layer MAL is thin, it is not always necessary to make the metal membrane upper layer MAL thicker than the metal membrane lower layer MDL since Mo suppresses the oxidation of Cu.

Subsequently, the inter-layer membrane INS3 is processed to open the electron emission portion. The electron emission portion is formed in a part of a cross portion between one lower electrode DED within the pixel and a space interposed between two upper bus electrodes (a laminated membrane of the metal membrane lower layer MDL, the metal membrane intermediate layer MML, and the metal membrane upper layer MAL, and a laminated membrane of the metal membrane lower layer MDL, the metal membrane intermediate layer MML, and the metal membrane upper layer MAL in an adjacent pixel not shown) which cross the lower electrode DED. The etching process can be performed by dry etching using an etching gas that mainly contains, for example, CF₄ or SF₆.

Finally, the membrane of the upper electrode AED is formed. The membrane is formed through the sputtering method. The upper electrode AED is formed of, for example, a laminated membrane of Ir, Pt, and Au, and its thickness is, for example, 6 nm. In this situation, the upper electrode AED is cut by a retraction portion (EG2) of the metal membrane lower layer MDL with a seam structure of the metal membrane intermediate layer MML and the metal membrane upper layer MAL in one (right side of FIG. 3C) of the two upper bus electrodes (a laminated membrane of metal membrane lower layer MDL, the metal membrane intermediate layer MML, and the metal membrane upper layer MAL). Then, in the other side (left side of FIG. 3C), the upper electrode AED is connected to the upper bus electrode (a laminated membrane of metal membrane lower layer MDL, the metal membrane intermediate layer MML, and the metal membrane upper layer MAL) without disconnection by a contact portion (EGI) of the metal membrane lower layer MDL to feed electricity to the electron emission portion.

FIG. 4 is an explanatory diagram showing an equivalent circuit example of a light emitting flat panel display device according to the present invention. A region indicated by a dotted line in FIG. 4 is a display region AR, and in the display region AR, the plural signal lines CL and the plural scanning lines GL intersect with each other to form an n×m matrix. The respective intersection portions of the matrix constitute the sub-pixels of color, and one pixel of color is constituted by one group of “R”, “G”, and “B” in the figure. The configuration of the cathode shown in FIG. 3 is omitted from the figure. The signal lines CL are connected to the signal line driver circuit DDR through the signal line terminals CLT, and the scanning lines GL are connected to the scanning line driver circuit SDR through the scanning line lead terminals GLT. An image signal (display data signal) NS is inputted to the data lien driver circuit DDR from an external signal source, and a scanning signal SS is inputted to the scanning line driver circuit SDR, likewise.

As a result, the image data is supplied to the sub-pixels that are connected to the scanning signal lines GL which are sequentially selected from the signal lines GL, thereby making it possible to display a full-color image of two dimensions. With the display device according to this structural example, there is realized a light emitting flat panel display device with high quality and high efficiency.

In the above description, a configuration having the cathode formed of the MIM is exemplified, but the present invention is not limited to this configuration, but similarly, the present invention is applicable to a light emitting flat panel display device using the above various electron sources.

What is claimed is:

1. A display device, comprising:
a back panel including a large number of scanning lines that extend in a first direction, are arranged in a second direction which crosses the first direction, and supplies a horizontal scanning signal, a large number of signal lines that extend in the second direction so as to interpose an insulating layer between the signal lines and the scanning lines, and arranged in the first direction, a drive signal of display data being supplied to the signal lines, and cathodes that connect the scanning lines and the signal lines;
a front panel including phosphor layers of plural colors which emit light by excitation of electrons that are extracted from the cathodes, and an anode that applies an accelerating voltage to an electron source; and
a sealing frame that is interposed in a peripheral portion between the back panel and the front panel to produce a depressurized internal space,
wherein: a plurality of pixels that are formed of a plurality of sub-pixels are arranged in a matrix to constitute a two-dimensional display region; and
when Ry is a vertical resolution of the display region, η is a cathode efficiency, Ies is a peak current per color sub-pixel, Ed [V] is the maximum amplitude of a drive voltage that is applied to the signal lines, b is the number of gradation bits, and SR[Ω/□] is a sheet resistance of the signal lines, SR<η·Ed/3·2^{b}·Ies·Ry is satisfied.

2. A display device, comprising:
a back panel including a large number of scanning lines that extend on a main surface in a first direction, are arranged in a second direction which crosses the first direction, and supplies a horizontal scanning signal, a large number of signal lines that extend in the second direction so as to interpose an insulating layer between the signal lines and the scanning lines, and arranged in the first direction, a drive signal of display data being supplied to the signal lines, and cathodes that connect the scanning lines and the signal lines;
a front panel including phosphor layers of plural colors which emit light by excitation of electrons that are extracted from the cathodes, and an anode that applies an accelerating voltage to an electron source; and
a sealing frame that is interposed in a peripheral portion between the back panel and the front panel to produce a depressurized internal space,
wherein: a plurality of pixels that are formed of a plurality of sub-pixels are arranged in a matrix to constitute a two-dimensional display region; and
when V [m] is a diagonal dimension of the display region, Rx is the number of pixels in a horizontal direction, Ea [V] is an anode voltage, Eaₜₕ [V] is a light emission start anode voltage, q is a cathode efficiency, Bp [cd/m²] is a peak brightness, Ed [V] is the maximum amplitude of a drive voltage, b is the number of gradation bits, and SR[Ω/□] is a sheet resistance of the signal lines, SR<Cη·Ed(Ea−Eaₜₕ)·Rx/3·2^{b}·Bp·V² (C is a constant) is satisfied.

3. A display device, comprising:
a back panel including a large number of scanning lines that extend in a first direction, are arranged in a second direction which crosses the first direction, and supplies a horizontal scanning signal, a large number of signal lines that extend in the second direction so as to interpose an insulating layer between the signal lines and the scanning lines, and arranged in the first direction, a drive signal of display data being supplied to the signal lines, and cathodes that connect the scanning lines and the signal lines;
a front panel including phosphor layers of plural colors which emit light by excitation of electrons that are extracted from the cathodes, and an anode that applies an accelerating voltage to an electron source; and
a sealing frame that is interposed in a peripheral portion between the back panel and the front panel to produce a depressurized internal space,
wherein: a plurality of pixels that are formed of a plurality of sub-pixels are arranged in a matrix to constitute a two-dimensional display region; and
when V [m] is a diagonal dimension of the display region, Rx is the number of pixels in a horizontal direction, Ea [V] is an anode voltage, η is a cathode efficiency, Bp [cd/m²] is a peak brightness, and SR[Ω/□] is a sheet resistance of the signal lines, SR<0.00047η·(Ea−3000)·Rx/Bp·V² is satisfied.

4. A display device, comprising:
a back panel including a large number of scanning lines that extend in a first direction, are arranged in a second direction which crosses the first direction, and supplies a horizontal scanning signal, a large number of signal lines that extend in the second direction so as to interpose an insulating layer between the signal lines and the scanning lines, and arranged in the first direction, a drive signal of display data being supplied to the signal lines, and cathodes that connect the scanning lines and the signal lines;
a front panel including phosphor layers of plural colors which emit light by excitation of electrons that are extracted from the cathodes, and an anode that applies an accelerating voltage to an electron source; and
a sealing frame that is interposed in a peripheral portion between the back panel and the front panel to produce a depressurized internal space,
wherein: a plurality of pixels that are formed of a plurality of sub-pixels are arranged in a matrix to constitute a two-dimensional display region; and
when a diagonal dimension of the display region is nominal 32 inches, the number of pixels in a horizontal direction is 1366, the number of pixels in a vertical direction is 768, an anode voltage is 7 kV, a cathode efficiency is η, and a peak brightness is 500 [cd/m²], a sheet resistance of the signal lines SR [Ω/□] satisfies SR<7.775η.

5. The display device according to claim 4,
wherein the sheet resistance of the signal lines is 0.38875 [Ω/□].
